(19) United States
(12) Patent Application Publication
(10) Pub. No.: US 2004/0126194 A1
(43) Pub. Date: Jul. 1, 2004

(54) Cutting tool, electric broaching tool equipped with same

(76) Inventor: Claude Monsieur Fioroni, Castres (FR)

Correspondence Address: Pendorf & Cutliff, 5111 Memorial Highway, Tampa, FL, 33634-7356, US

(21) Appl. No.: 10/471,218

(22) PCT Filed: Mar. 7, 2002
(86) PCT No.: PCT/FR02/00824

(30) Foreign Application Priority Data
Mar. 7, 2001 (FR) 01/03433

(51) Int. Cl. B23B 47/00

(52) U.S. Cl. 408/68; 409/137

(57) ABSTRACT

The invention concerns a high-speed dry-process-machining tool (O) comprising a body (100) whereof one first end (110) includes material removing means (200) and the other end (120) is connected to a driver. The invention is characterized in that the end (110) including the material removing means (200) is provided with an orifice (111) opening onto an internal conduit (130) which, when set under negative pressure, evacuates by air displacement the shavings produced by said material removing means (200). The invention also concerns an electric broaching tool and a machine-tool equipped therewith. The invention is applicable to high-speed machining.

### FIELD OF APPLICATION OF THE INVENTION

The present invention relates to tools in the field of machine tools and more particularly with the adoptions of tools intended for processing at very high speed.

### DESCRIPTION OF THE PRIOR ART

The piercing and drilling process are traditionally done by comparable tools with one or two sharp ridges at their ends and lateral gouges allowing the evacuation of the material in the form of shavings (drillings, piercings). In order to cool down or to participate in the evacuation of the shavings produced inside cylindrical fabrication, these tools are often equipped with internal conduit having the function of assuring the projection of a cooling or evacuating fluid on the area of the cut. This projection of cooling and/or evacuating fluid might be done by an external means such as projection ducts.

In order to gain time during the creation of holes, notably by the reducing the amount of tools changed during the (drilling tools, then piercing tools), recent developments have allowed the combination of piercing and drilling operations with the help of a unique tool that utilizes the possibility of generating trajectories from the machines with modern numerical commands that are capable of creating at their point, a spiral trajectory.

The applicant noticed that today, the performances of processing had reached a maximum level because of a principal parameter, that is, the fragility of the tool. Therefore, for example, in the light combination field, the speed of the drill reaches 600 meters a minute today. Indeed, the presence of lateral gouges with an evacuation method of cuts and those of central piercings made on the tools in order to project fluid in on one hand for evacuating the cuts and on another hand for high pressure watering, affect those sections of the tools, making them very weak and fragile. One problem is that these tools are very breakable. Besides the requirement of a certain speed of cut, these tools need to be long lasting.

Therefore, the performance of the cutting head causes these tools to have to be replaced more and more often, which increases the cost of manufacturing the pieces, not only in the number of tools utilized, but also in the time required to change the tools. Reducing or removing these costs and this time was a primary objective for using such tools.

In order to resolve these inconveniences, the makers of the tools have invented tools capable of assuring the evacuation of the created cuts without the need of the presence of lateral gouges.

Therefore, the American document no. 2,895,355 describes the high-speed process-machining tool comprising a body whereas one first end includes material removing means and whereas the second end is connected to a cutting head. These tools are provided with an internal conduit opening at the cut level element. This assures (in cooperation with the cooling and/or evacuating liquid), the evacuation of the shavings from the cutting end of the tool toward the interior. The optimized evacuation of the shavings allows the drill to operate at high speeds.

It is the same in the English document no. 760,353 that proposes a tool providing an internal conduit allowing the evacuation of liquid with the shavings.

The American document describes in its own way a tool more complex than what was described earlier, which proposes at its edges conduits for the projection of a liquid and conduits for the evacuation of the resulting solution formed by both the liquid and shavings that were created during the processing.

The newness of these tools resided in the fact that the conduit defined an evacuation path of shavings and fluid. Likewise, the presence of this evacuation conduit, and not of the projection conduit, avoided the necessity of making the gouges on the exterior surface of the tool, the gouges that were one of the causes of the fragility of the tools of the previous method.

Therefore, evolving standards and a respect for the environment made the criteria of the tools conception evolve. So, a new criterion of the tools conception resides in need to realize dry-process-machining. This means machining without either cooling or evacuation fluid. This new criterion prevents pollution caused by the liquid, but makes it particularly difficult to evacuate the shavings caused by the processing. The evacuation of shavings by the conduit located inside a tool during a dry-process-machining creates in a technical difficulty impossible to overcome by the usual techniques. Indeed, these evacuation tools or devices that have been described earlier could not meet this new criterion because of the evacuation and/or cooling fluid created by its projected kinetic energy. The evacuation and/or cooling fluid comprises the main portion of the material evacuated throughout the canals that are made for this purpose inside the tools, with the shavings comprising only a small portion of the material evacuated.

### DESCRIPTION OF THE INVENTION

Departing from this stage of events and the new criteria, the applicant has conducted research in order to avoid the drawbacks mentioned. This research has led to the realization of a new concept of cutting tool not only capable of bearing the constantly growing forces from the high speed processing, but also to improve the quality of processing realized with complete respect of processing criteria defined by the dry-process-machining. This concept of tool could apply not only to the classical tools, but also to those of assuring the operations of piercing and drilling simultaneously. This new tool has for a goal to ability to conduct cut above the speed of 1,000 meters a minute.

According to the principal characteristic of the invention, the high speed dry-process-machining tool contains a body whereas one first end includes a material moving means and whereas a second end is connected to a cutting head. This tool is characterized by the fact that the end including the material removing means includes an orifice opening over an internal conduit that, under negative pressure, evacuates shavings by air displacement during the processing operation.

Such a tool has the advantage of possessing a high rigidity, a central conduit and an exterior surface without gouges. To accomplish this, this type of tool does not require the use of a conduit for projecting fluid for the evacuation of the shavings, because the central conduit accomplishes that function. This type of tool is particularly well adapted to processing not only at high speed, but also equally when dry, because only the air and the shavings are evacuated. This characteristic is not evident with respect to the previous method because the dry processing constitutes a criterion of particularly recent conception.

This dry processing is desirable for the reasons of: overcoming the problem of fluid adhesion, the production of very little, easily transported fragments of shavings, and the evacuation of heat inside the shavings.

The tool of the invention is particularly favorable because it requires neither cutting fluid for cooling nor fluid for evacuating the shavings inside the tool.

Also, although the realization of an evacuation conduit is not new, today these last ones are used differently in order to meet the criteria of a new conception within a new application of dry processing.

This technological solution of shavings evacuation is particularly simple and very easy to produce. Therefore, this tool has the advantage of reaching the constraints related to the cooling, because the creation of negative pressure in its internal conduit assures a circulation of enough air to accomplish this function. In addition, this solution of the shavings evacuation is particularly suitable to the process of machining at a very high speed that generates micro-shavings that are incompletely expelled to the exterior by classical means. An integrated suction tool that produces said micro shavings assures the best possible evacuation. The constant suction of the shavings by the current processing guarantees a superior quality of operation and avoids the apparition of the shavings waste that, despite the projection of fluid, established, for the tools of the previous method and notably for those assuring the operations of piercing and/or drilling, risks a bad quality processing or tool altering.

Also, this use of a known means within a new application brings new advantages. In knowing that micro shavings will be created, the consequences of the dry processing at very high speeds (allowed by the simultaneous evacuation of the shavings) are perfectly taken into account by this new evacuation means. Therefore, the characteristics of the combination mutually reinforce their effects, resulting in a new technique.

The act of negatively pressurizing the evacuation conduit for shavings inside the tool, and also the presence of this conduit itself, has the consequence of creating an immediately suitable environment.

Also, this invention equally includes both the electric broaching tool as well as a machine tool adopting such an invention.

The fundamental concepts of the invention just described above are in their most elementary form. Other details and characteristics will appear clearer within the reading of the following description with reference to the appended drawings, given as non-limiting examples of a variant of a cutting tool of the invention.

### BRIEF DESCRIPTION OF THE DRAWINGS

FIG. 1a is a cut profile view of a realization method of a tool in compliance with the invention,

FIG. 1b is a side view of the tool in FIG. 1a,

FIG. 2a is a cut profile view of a realization method of a second tool in compliance with the invention,

FIG. 2b is a side view of the tool of the FIG. 2a,

FIG. 3a is a cut profile view of a realization method of a third tool in compliance with the invention, and

FIG. 3b is a side view of the tool of the FIG. 3a.

### DESCRIPTION OF THE PREFERRED VARIANTS

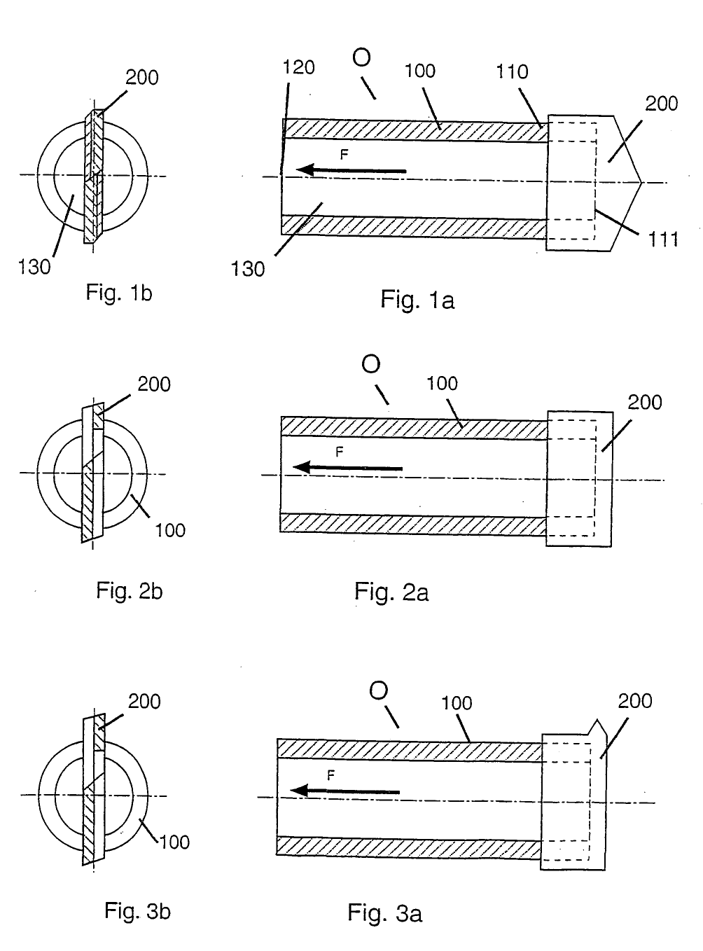

As illustrated in the drawings of FIGS. 1a, 2a, 3a, the processing tool, referenced O as a whole, is a type of which includes a body 100, here extended, wherein a first end 110 includes a material removing means 200, and wherein the second end 120 is connected to a cutting head (not illustrated) which could be formed, for example, by an electric broaching tool. According to a non-limiting variant, the first end 110, including the removing material means 200, is equipped with an orifice 111 opening into an internal conduit 130 created inside the body of the tool O and by which the shavings produced by the removing means 200 are evacuated.

According to a non-limiting variant, the internal conduit 130 opens on the two ends 110 and 120 of body 100 of the tool O.

According to a non-limiting variant, the internal conduit 130 is built by a cylindrical hole, wherein the axis corresponds to the rotation axis of the tool and opens at the two ends of the body of the tool O. Indeed, according to the technical choice illustrated, the internal conduit is formed by the empty volume of a cylinder that forms the body 100 opened at its two ends 110 and 120, wherein the first end 110 contains the cutting sides of the material removing means 200. This realization method is particularly favorable because of the simplicity of its conception. The use of a cylinder 100 considerably simplifies the development of an evacuation conduit 130 of the shavings on the rotational axis of the tool without requiring the removal of material. The use of a cylindrical hole otherwise defines a particularly steady internal conduit, which will facilitate the evacuation of the shavings. Indeed, it is particularly important to eliminate all obstacles to the evacuation of shavings in order to avoid all deposits or creation of deposits inside the tool O. In addition, the strength of a cylindrical hole is different from classical tools with gouges and projection conduits of fluid, and it will be much more capable of supporting the constraints required by high speed processing.

In no circumstance should the use of a cylinder pipe be considered limiting, especially concerning the exterior surface that can be made of a high thickness at the linking level with electric broaching tool or the cutting head of the tool O.

According to the invention, the internal conduit 130 of the tool O is negatively pressurized in order to evacuate the shavings produced by its first end 110 equipped with a material removing means 200. As illustrated, the produced shavings move from a forward position of the tool towards a backward position, following referenced arrow F, as a result of the suction action.

As illustrated in the drawings of FIGS. 1b, 2b, 3b, the cutting side of the cutting head occupies a plane crossed by the axis of conduit 130 and leaves a free space of the orifice 111 and the conduit 130 in a way that the produced shavings can be evacuated by the conduit 130. Indeed, the shavings produced by the material removing means 200 represent such a thickness that they are located at the end 110 of the pipe 100; they do not overwhelm the entire orifice 111 of the internal conduit 130, and they leave free the biggest part as illustrated. Therefore, all of the shavings produced by the small cutting blade will be inevitably suctioned by the orifice 111 throughout the internal conduit 130 of the tool O toward rear of the pipe 100 following arrow F. In the general manner, the material removing means 200 is related to the end of the pipe 100 in a way that the orifice 111 defined by the internal conduit 130 stays open so that the shavings will be able to pass through the internal conduit 130 created inside the body 100 of the tool O.

According to a preferred, but non-limiting variant, the tool O is made up of a highly rigid material for its body, meaning the pipe 100 and at least one cutting blade assembly at the end 110 of the body 100 for the material removing means 200. The assembly is a known technique and does not represent any special difficulty. Therefore, the applicant designed a tool O capable of avoiding the flaws of the classical tools used until now, with reducing the difficulty and manufacturing in mind. The guaranteed evacuation of the shavings also has the advantage of the quality of realized processing.

FIGS. 1a and 1b illustrate a method of realization of a piercing tool O by an orbital movement across its axis of rotation.

FIGS. 2a and 2b illustrate a method of realization of a piercing tool O by an orbital movement across the axis of rotation.

FIGS. 3a and 3b illustrate a method of realization of a piercing and drilling tool O by an orbital movement along the axis of rotation.

These tools are particularly suitable to the machine tools susceptible of assuring the helicoidally orbital movements of installed tools at the end of broach or electric broaching tool.

As explained earlier, the creation of negative pressure and the presence of the internal evacuating conduit 130 of the shavings inside tool O require the immediate adaptation of the tool environment. Therefore, according to a variant that is particularly favorable, the electric broaching tool (not illustrated) suitable to the activation of the tool O is characterized in a way that it is suitable to a negative pressurized conduit and that has a goal of evacuating the shavings that pass through the internal conduit 120 of the tool O. This electric broaching tool itself could contain an internal axial conduit where the shavings will pass through. A driver of the machine tool (not illustrated here) could create negative pressure in the tool O of the invention, which is characterized in a way that it contains a suction method with a goal of negatively pressurizing the internal conduit provided inside the tool.

In the event that the electric broaching tool does not comprise central suction, the driver can create suction by creating negative pressure in the conduit, which is located inside the electric broaching tool.

It is understood that the cutting tool, electric broaching tool and the machine tool equipped with the same have been described and presented above in the terms of a disclosure, not of a limitation. Naturally, various arrangement, modifications and improvements could be made to the aforementioned example without departing from the scope of the invention, taken in its broadest aspects and essence.

Therefore, for example, although an application on light alloy has been described, the applicant does not limit the kind of material processed.

1. Dry-process-machining tool (O) at high speed of the kind which containing a body (100) that one first end (110) includes a material removing means (200) and which the other end (120) is connected to a driver, CHARACTERIZED BY FACT THAT the end including the material removing means (200) is provided with an orifice (111) opening on an internal conduit (130) which, when set under negative pressure, evacuates by air displacement the shavings produced by said material removing means (200).

2. Process machining tool (O) upon the claim 1, CHARACTERIZED BY THE FACT THAT the said internal conduit (130) opens at the two ends (110 and 120) of body (100) of the tool (O).

3. Process machining tool (O) upon the claim 2, CHARACTERIZED BY THE FACT THAT said internal tool (130) is formed by an cylindrical volume hole which the axis corresponds to the rotational axis of the tool (O) and which opens at two ends (110 and 130) of the body (100) of the tool (O) in a way of forming at least two orifices.

4. Process machining tool (O) upon the claim 2, CHARACTERIZED BY THE FACT THAT the said material removing means (200) is related to the end (110) of the body (100) of the tool (O) in a way that the orifice (111) defined by the internal conduit (130) stays open in order that the shavings be able to pass through the internal conduit (130) made inside the body (100) of the tool (O).

5. Process machining tool (O) upon the claim 4, CHARACTERIZED BY THE FACT THAT the cutting part of the material removing means (200) contains a plane crossing by the axis of the conduit (130) in a way to leave a conduit space (130) authorizing the evacuation of the shavings.

6. Process machining tool (O) upon the claim 1, CHARACTERIZED BY THE FACT THAT the tool (O) is made up of a very hard material for its body (100) and at least a small cutting blade at the end (110) of the body (100) for the material removing means (200).

7. Electric broaching tool equipped with the activating tool (O) upon the claim 1, CHARACTERIZED BY THE FACT THAT it is provided with a conduit, which under negative pressure, evacuates the shavings passing through the internal conduit (130) of the tool (O).

8. Machine tool adapted to an activating tool (O) upon the claim 1, CHARACTERIZED BY THE FACT THAT it includes a suction means with the goals of setting under negative pressure of the internal conduit (130) made inside the tool (O).

9. Machine tool adapted to an activating tool (O) upon the claim 1, CHARACTERIZED BY THE FACT THAT it includes a suction means with the goals of setting under negative pressure of the conduit made inside the electric broaching tool.
